(19) United States
(12) Patent Application Publication
(10) Pub. No.: US 2013/0118694 A1
(43) Pub. Date: May 16, 2013

(54) SCREEN DEVICE

(71) Applicants: Hirofumi Moriya, Nerima-ku (JP); Takashi Moriya, Tokorozawa-shi (JP)

(72) Inventors: Hirofumi Moriya, Nerima-ku (JP); Takashi Moriya, Tokorozawa-shi (JP)

(73) Assignee: SEIKI SOGYO CO., LTD., Nerima-ku (JP)

(21) Appl. No.: 13/811,398

(22) PCT Filed: Jun. 24, 2011
(86) PCT No.: PCT/JP11/64501

§ 371 Date: Jan. 22, 2013

(30) Foreign Application Priority Data
Aug. 19, 2010 (JP) 2010-184398

(51) Int. Cl. E06B 3/48

(52) U.S. Cl. CPC E06B 3/48
USPC 160/84.04

(57) ABSTRACT

A screen device including a parallel motion mechanism using wires inserted into a screen, an upper part of the screen being restricted from bending by external forces such as wind. One end of a screen made expandable and contractible by alternate folding in opposite directions is connected to a longitudinal frame member of a screen frame, and another end is connected to a movable frame to make the screen openable and closable by lateral pulling. A parallel motion mechanism moving parallel the movable frame by flexible linkage members including wires is inserted in an expansion and contraction direction of the screen. A part of the wires are tensioned along a portion above the screen as wires for hanging the screen and are inserted into an inner hole of a ring portion of a hanging member, the upper end of the screen being sandwiched by a sandwiching portion of the hanging member.

### TECHNICAL FIELD

The present invention relates to a screen device suitable to be used in an opening of a building for the purpose of protection against insects, shading, blinding, heat insulation, interior decoration, partition and the like. More specifically, the present invention relates to a screen device having a screen made openable and closable through lateral pulling by moving a movable frame parallel by a parallel motion mechanism using wires inserted into the screen, the screen device eliminating a need for detaching the wires when making the longitudinal dimensions thereof adjustable by cutting upper portions of the screen, the movable frame, and the longitudinal frame members of the screen frame in site construction of the screen device, and further preventing the upper end of the screen from bending by an external force such as wind since the upper end of the screen is hanged on the wires.

### BACKGROUND ART

A screen device in which an expandable and contractible screen folded in opposite directions alternately is made openable and closable by lateral pulling, and, to the screen and a movable frame connected to one end of the screen, a parallel motion mechanism that restricts the posture of the movable frame is adjacently provided, is usually produced in a factory in a standard dimension. At the construction site of such screen device, the screen, the movable frame, the longitudinal frame members of the screen frame are often cut to adjust the longitudinal dimensions thereof so as to be adapted to the longitudinal dimension of the opening of a building. In such case, since the movable frame is provided with the parallel motion mechanism constituted by the wires, adjustment of the longitudinal dimensions requires detachment of the wires from the screen and the longitudinal frame members so as to prevent cutting of the wires. Accordingly, the adjustment operation is not always easy.

In order to facilitate adjustment of the longitudinal dimension of the screen frame, Patent Document 1, for example, already proposes a screen device, that eliminates a need to detach the wires when adjusting the longitudinal dimension of the screen frame, by eliminating the wires in an area that enables adjustment of the longitudinal dimensions of the screen, the movable frame, and the longitudinal frame members of the screen frame, namely, a certain area in upper portions of the screen and the like.

However, in the already-proposed screen device mentioned above, the wire is not inserted into a certain area in the upper portion of the screen, and hence this screen device is inferior in surface strength. Accordingly, there is a possibility that an external force such as wind bends the upper portion of the screen. Once the screen is bent, the possibility of automatically restoring by itself is not always high, which means an operation of extending the bent portion is required each time.

### PRIOR ART DOCUMENT

### Patent Document

Patent Document 1: Japanese Patent Application Laid-open No. 2010-37857

### SUMMARY OF THE INVENTION

### Problems to be Solved by the Invention

A technical object of the present invention is to provide a screen device having the parallel motion mechanism using wires inserted into a screen, the screen device eliminating wires and other elements necessary to be detached from the upper portion of the screen, thereby facilitating adjustment of the longitudinal dimensions of the screen, the movable frame, and the longitudinal frame member of the screen frame through cutting the upper portions thereof while restricting the upper portion of the tensioned screen from bending by an external force such as wind.

### Means for Solving the Problem

In order to achieve the above-mentioned object, the present invention provides a screen device of a first aspect of this invention including: a screen frame installed in an opening of a building; a pair of longitudinal frame members in the screen frame; a movable frame for an opening and closing operation guided by the screen frame; a screen that is expandable and contractible by being folded in opposite directions alternately, the screen having one end connected to one of the pair of longitudinal frame members and an another end connected to the movable frame, the screen being made openable and closable by lateral pulling; a parallel motion mechanism for moving parallel the movable frame; wires inserted into the screen in an expansion and contraction direction of the screen at a plurality of levels; and a flexible linkage member including the wires, the flexible linkage member retaining a posture of the movable frame in an upright state regardless of a position of the movable frame, in which a part of the wires constituting the parallel motion mechanism are tensioned in a lateral frame member without being inserted into the screen along a portion above the screen so as to hang the screen, the lateral frame member being provided in an upper part of the screen frame; and a hanging member for hanging the screen on the part of the wires used for hanging the screen includes a ring portion having an inner hole into which the part of the wires used for hanging the screen are inserted, and a sandwiching portion for sandwiching an upper end of the screen.

In the preferred embodiment of the screen device of the first aspect of this invention, respective one end portions of the plurality of wires constituting a part of the parallel motion mechanism are fixed to the movable frame; the wires are inserted into the screen in the expansion and contraction direction of the screen discretely at a plurality of levels, the wires are deflected upward in one of the longitudinal frame members opposed to the movable frame through an intermediation of the screen, the wires are further deflected at an upper end of the one of the longitudinal frame members toward an another one of the longitudinal frame members, then turned back at the another one of the longitudinal frame members by a deflector, and fixed to an upper end of the movable frame, and a flexible linkage member attached to a lower end of the movable frame is deflected at a lower end of the one of the longitudinal frame members to which the screen is attached, guided to the upper end of the one of the longitudinal frame members, deflected at the upper end, turned back at the another one of the longitudinal frame members, and fixed to the upper end of the movable frame.

In order to achieve the above-mentioned object, the present invention provides a screen device of a second aspect of this invention including: a screen frame installed in an opening of a building; a pair of longitudinal frame members of the screen frame; movable frames for an opening and closing operation guided by the screen frame; screens that are expandable and contractible by being folded in opposite directions alternately, the screens each having one end connected to the pair of longitudinal frame members and an another end connected to the movable frames, the screens being made openable and closable by lateral pulling; parallel motion mechanisms for moving parallel the movable frames; wires inserted into the respective screens in expansion and contraction directions thereof at a plurality of levels; and flexible linkage mechanisms including the wires, the flexible linkage mechanisms retaining postures of the respective movable frames in upright states regardless of positions of the movable frames, in which a part of the wires constituting the parallel motion mechanisms are tensioned in a lateral frame member without being inserted into the screen along portions above the screens so as to hang the screens, the lateral frame member being provided in an upper part of the screen frame; and a hanging member for hanging the screens on the part of the wires used for hanging the screens includes a ring portion having an inner hole into which the part of the wires used for hanging the screens are inserted, and a sandwiching portion for sandwiching upper ends of the screens.

In a preferred embodiment of the screen device of the second aspect of this invention, respective one end portions of the plurality of wires constituting a part of the parallel motion mechanisms are fixed to the paired movable frames; the wires are inserted into the respective screens in the expansion and contraction directions of the screens discretely at a plurality of levels, the wires are deflected upward in the longitudinal frame members opposed to the movable frames, respectively, through the intermediation of the screens, the wires are further deflected at upper ends of the respective longitudinal frame members toward the longitudinal frame members provided on other sides therefrom, then turned back by deflectors at positions at least beyond a position where the movable frames meet each other, and fixed to upper ends of the movable frames, flexible linkage members attached to lower ends of the respective movable frames are deflected at lower ends of the respective longitudinal frame members to which the screens are attached, guided to the upper ends of the longitudinal frame members, then deflected toward the longitudinal frame members provided on the other sides therefrom, turned back at positions at least beyond the position where the movable frames meet each other, and fixed to the upper ends of the movable frames.

In embodiments of the screen devices of the first and second aspects of this invention, the flexible linkage member attached to the lower end of the movable frame comprises: a flexible screen guide gets into and out of the longitudinal frame member opposed to the movable frame through the intermediation of the screen from a lower end thereof, is led out along a lower end of the screen when the screen is tensioned, and guides the lower end of the screen; and a wire that is connected to a top of the screen guide inserted into the longitudinal frame member from the lower end thereof and is guided to the upper end of the longitudinal frame member, and the wire may be guided to the upper end of the longitudinal frame member, turned back after being deflected toward the longitudinal frame members provided on an another side, and fixed to the upper end of the movable frame.

Further, in a preferred embodiment of the above-mentioned screen devices according to the present invention, it is preferable that the hanging member be integrally formed of a synthetic resin, a sandwiching portion of the hanging member be formed by bringing a pair of sandwiching plate portions sandwiching the screen into bendably contact with each other through the intermediation of a thin flexible portion, the pair of sandwiching plate portions be provided with protrusions that are pinned to the screen sandwiched between opposing surfaces of the pair of sandwiching plate portions and an engaging portion for holding the sandwiching plate portions in a joining state with the screen being sandwiched between the pair of sandwiching plate portions, and at least one of the sandwiching plate portions be integrally provided with the ring portion having a slit through which the part of the wires for hanging the screen thereon is inserted into the inner hole of the ring portion.

### Effect of the Invention

The screen device of the present invention described in detail above can provide a screen device having the parallel motion mechanism using wires inserted into a screen, the screen device eliminating wires and other elements necessary to be detached from the upper portion of the screen, thereby facilitating adjustment of the longitudinal dimensions of the screen, the movable frame, and the upper portion of the longitudinal frame member of the screen frame through cutting thereof while restricting the upper portion of the tensioned screen from bending by an external force such as wind.

### BRIEF DESCRIPTION OF THE DRAWINGS

FIG. 1 is a partially-broken front view illustrating a first embodiment of a screen device according to the present invention.

FIG. 2 is a longitudinal sectional view taken along a line II-II of FIG. 1.

FIG. 3 is a longitudinal sectional view taken along a line III-III of FIG. 1.

FIG. 4 is a lateral sectional view taken along a line IV-IV of FIG. 1.

FIG. 5 is a lateral sectional view taken along a line V-V of FIG. 1.

FIG. 6 is a schematic structural view of a parallel motion mechanism of a movable frame according to the first embodiment of the present invention.

FIG. 7 is an external perspective view illustrating a state in which a hanging member of the first embodiment is opened.

FIG. 8 is an internal perspective view illustrating a state in which a hanging member of the first embodiment is opened.

FIG. 9 is a front view illustrating a structure of an inner surface of the hanging member in an opened state.

FIG. 10 is a plane view illustrating the structure of the inner surface of the hanging member in the opened state.

FIG. 11 is a right-side view of FIG. 9.

FIG. 12 is a left-side view of FIG. 9.

FIG. 13 is a plane view illustrating the hanging member in a middle state of closing the hanging member from the state of FIG. 10.

FIG. 14 is an enlarged perspective view illustrating a state in which the screen is hanged on the hanging member.

FIG. 15 is a perspective view illustrating a second embodiment of a screen device according to the present invention.

### EMBODIMENTS FOR CARRYING OUT THE INVENTION

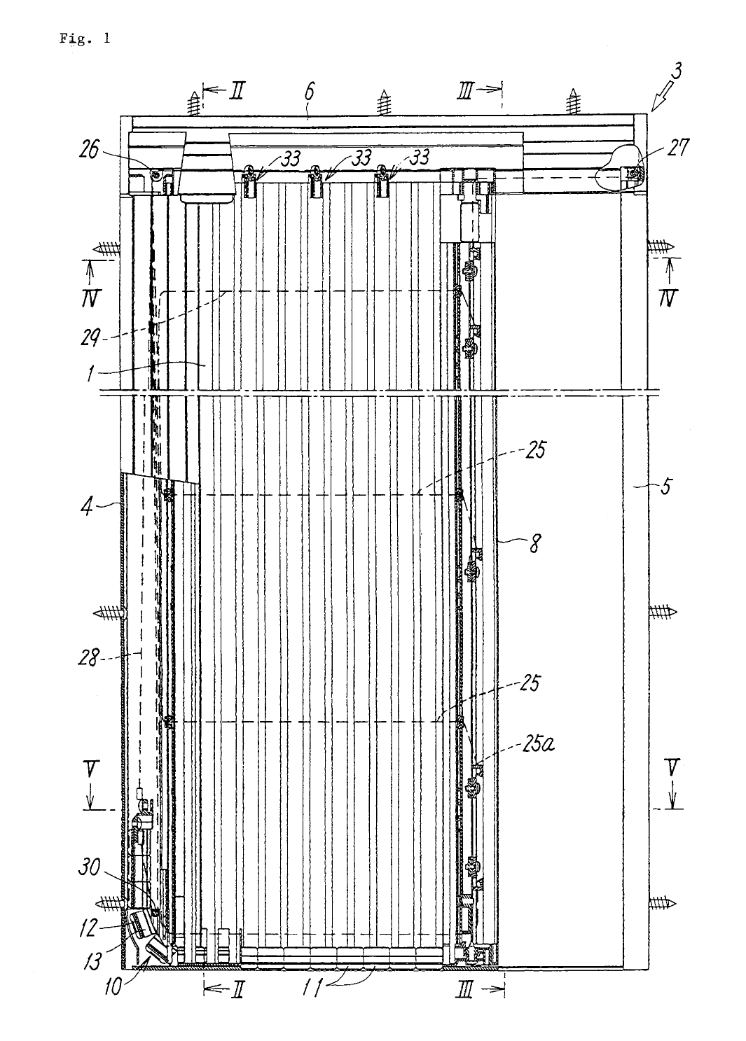

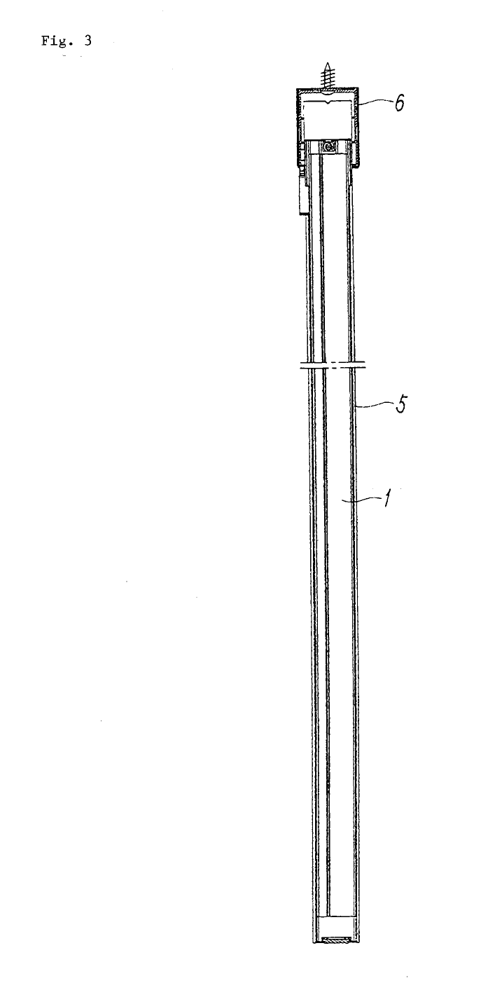

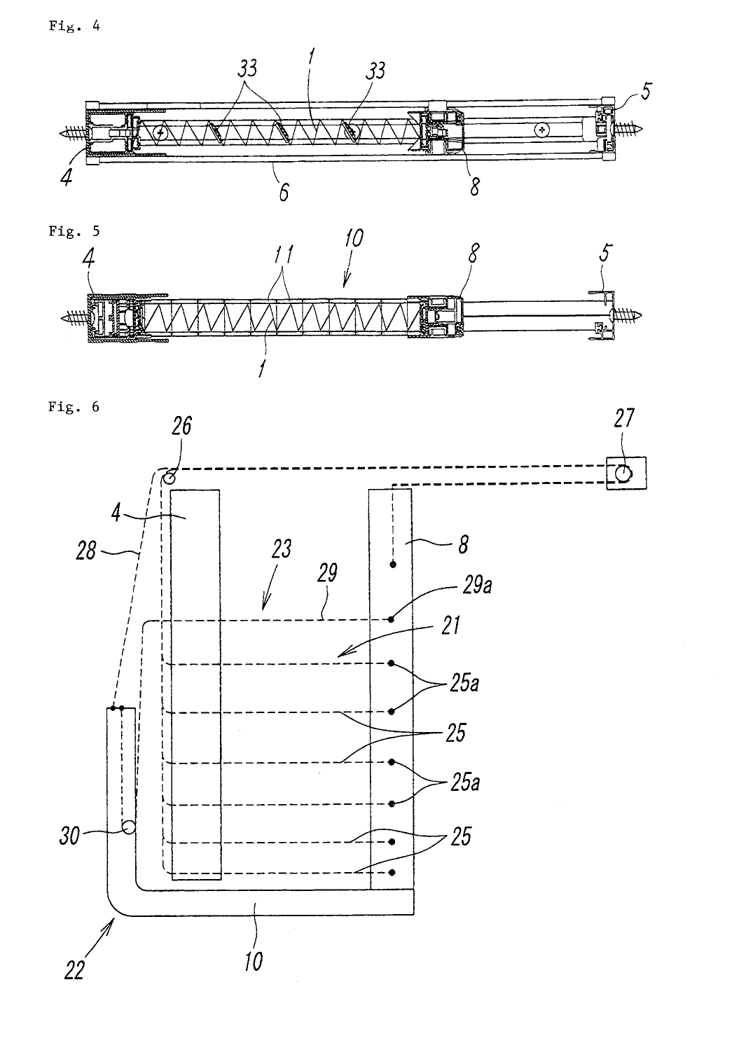

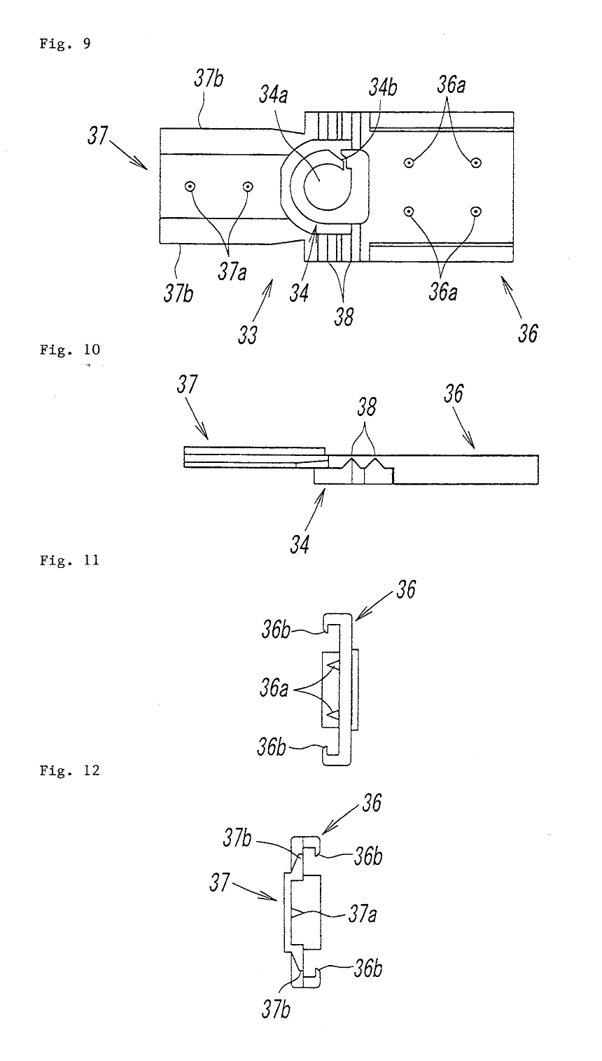

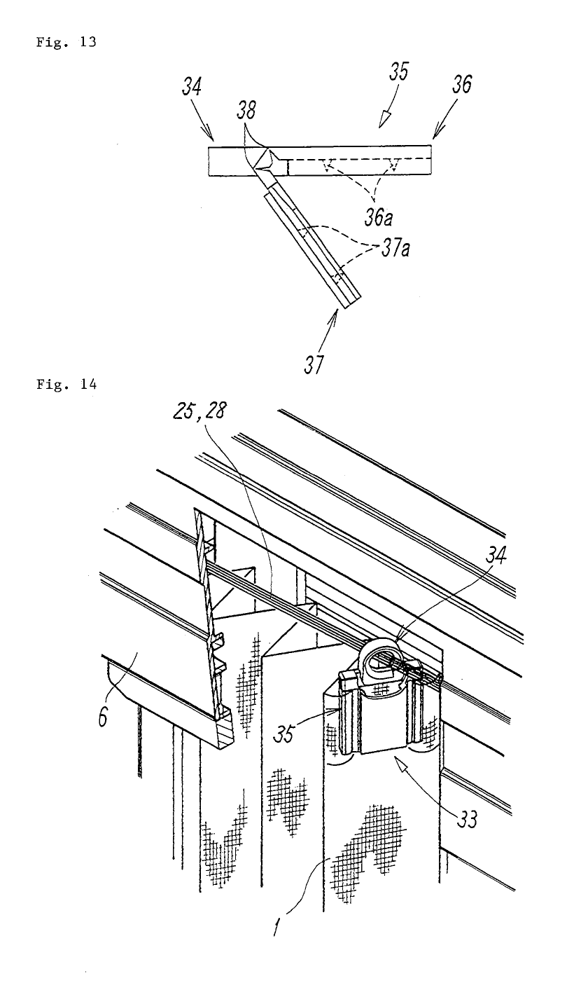

FIGS. 1 to 14 illustrate a first embodiment of a screen device according to this invention. This screen device is mainly installed in an opening of a building for the purpose of protection against insects, shading, blinding, heat insulation, interior decoration, partition and the like. The screen device includes a screen frame 3 that is fixedly mounted in the opening of a building and openably and closably tensions a screen 1 used for a certain purpose. The screen 1 is provided with a large number of parallel pleats that are formed by folding the screen 1 in opposite directions alternately, the pleats being expandable and contractible by folding. The screen 1 can be constituted as, for example, an insect net door by using an insect net as a material of the screen 1.

Further, the screen frame 3 includes a pair of longitudinal frame members 4 and 5 that are arranged on right and left sides of the opening of a building, and a lateral frame member 6 provided on the upper side for connecting upper ends of the longitudinal frame members 4 and 5. The screen 1 has one end that is connected to the longitudinal frame member 4 provided on one side and an another end connected to a movable frame 8 for an opening and closing operation guided by the lateral frame member 6 of the screen frame 3. The screen 1 is thus made openable and closable by lateral pulling. In this screen device, the longitudinal frame member 5 provided on the other side with which the movable frame 8 comes into contact when the screen 1 is tensioned by the movable frame 8 functions as a receiving frame for the movable frame 8. Although a lateral frame member on the lower side for connecting lower ends of the longitudinal frame members 4 and 5 may be provided, here is shown as described below a lateral frame member with a barrier-free structure including a screen guide 10 that is connected to the lower end of the movable frame 8, moves together with the movable frame 8, and goes into and out of the longitudinal frame member 4 on one side.

The movable frame 8 for opening and closing the screen 1 is adjacently provided with a parallel motion mechanism for moving parallel the movable frame 8. This parallel motion mechanism is structured so that first to third flexible linkage members 21 to 23 (see FIG. 6) for holding the posture of the movable frame 8 in an upright state regardless of the position at which the movable frame 8 is opened or closed, the first to third flexible linkage members 21 to 23 including wires 25 inserted into the screen 1 in the expansion and contraction direction thereof at a plurality of levels.

Referring to FIGS. 1 to 6, structures of the first to third flexible linkage members are described in detail. Firstly, the first flexible linkage member 21 constituting the parallel motion mechanism is constituted by a plurality of wires 25. Respective one end portions 25a of the plurality of wires 25 are discretely fixed to the movable frame 8 in upper and lower directions thereof. These wires 25 are inserted into the screen 1 in the expansion and contraction direction thereof at a plurality of levels approximately equidistant from each other. The wires 25 are deflected upward at the longitudinal frame member 4 opposed to the movable frame 8 through the intermediation of the screen 1. At the upper end of the longitudinal frame member 4, the wires 25 are further deflected toward the longitudinal frame member 5 provided on the other side by a deflector 26 provided in the lateral frame member 6. Thereafter, in the longitudinal frame member 5, the wires 25 are turned back by a deflector 27, and fixed to the upper end of the movable frame 8.

The plurality of wires 25 constituting the first flexible linkage member 21 may be collected as one wire in portions where the plurality of wires 25 gather and move in the same direction.

The second flexible linkage member 22 constituting the parallel motion mechanism includes a screen guide 10 and a wire 28. The screen guide 10 moves together with the movable frame 8 with being connected to the lower end of the movable frame 8, and goes into and out of the longitudinal frame member 4 from the lower end thereof, the longitudinal frame member 4 being opposed to the movable frame 8 through the intermediation of the screen 1. The wire 28 is connected to a top of the screen guide 10 existing in the longitudinal frame member 4.

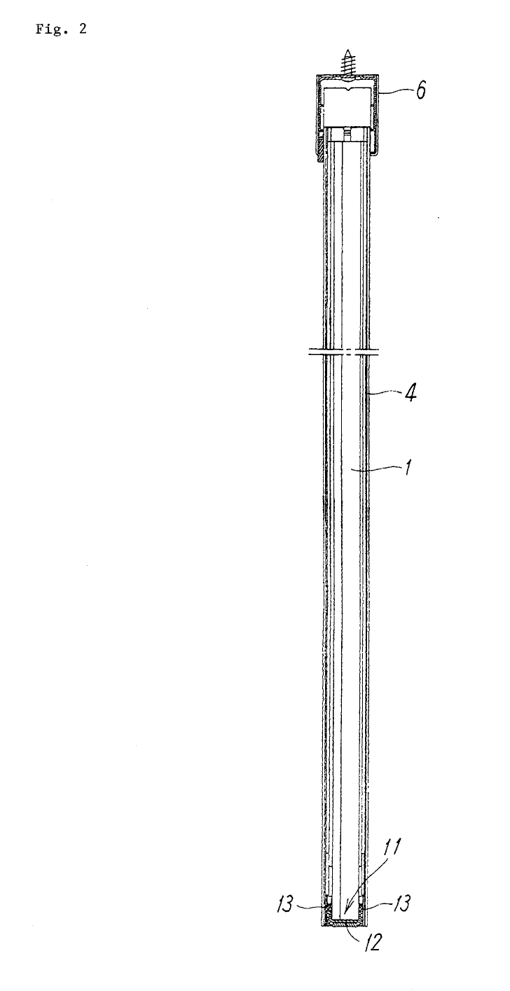

As shown in FIGS. 1 and 2, the screen guide 10 attached to the lower end of the movable frame 8 is constituted by a large number of guide units 11 each formed by a bottom wall 12 and a pair of side walls 13 so as to have a U-shaped cross section. The large number of guide units being serially tied so as to curve upward concavely by a small-diameter wire inserted along the upper end portions of the pair of side walls 13. The screen guide 10 goes into and out of the longitudinal frame member 4 from the lower end thereof in accordance with expansion and contraction of the screen 1 caused by motion of the movable frame 8. Then, the screen guide 10 is led out along the lower end of the screen 1 tensioned by motion of the movable frame 8, retain the lower end of the screen 1 between the pair of side walls 13, and prevent the lower end of the screen 1 from swinging by wind and the like.

As descried above, the screen guide 10 constituting a part of the second flexible linkage member 22 attached to the lower end of the movable frame 8 is guided to the upper side in the longitudinal frame member 4 after being deflected at the lower end of the longitudinal frame member 4. The above-mentioned wire 28 is connected to the top of the screen guide 10, the top constantly existing inside the longitudinal frame member 4 regardless of the position to which the movable frame 8 moves. This wire 28 is deflected by the deflector 26 provided to the lateral frame member 6 at the upper end of the longitudinal frame member 4, and guided toward the longitudinal frame member 5 on the other side. After that, the wire 28 is turned back by the deflector 27 provided to the longitudinal frame member 5, and fixed to the upper end of the movable frame 8.

The second flexible linkage member 22 as a whole may be constituted of one wire. In such case, it is sufficient that the wire attached to the lower end of the movable frame 8 is guided to the side of the longitudinal frame member 4 along the lower end of the screen 1, then deflected upward by a deflector provided to the lower end of the longitudinal frame member 4, thereafter deflected similarly to the wire 28 mentioned above by the deflector 26 at the upper end of the longitudinal frame member 4 so as to be guided toward the longitudinal frame member 5 on the other side, turned back by the deflector 27 provided to the longitudinal frame member 5, and fixed to the upper end of the movable frame 8.

Further, the plurality of wires 25 constituting the first flexible linkage member 21 have respective one end portions 25a connected to the movable frame 8. The wires 25 are inserted into the screen 1 in the expansion and contraction direction thereof at a plurality of levels. In addition, as a third flexible linkage member 23 constituting the parallel motion mechanism, there is provided a wire 29. The wire 29 that is positioned above the plurality of wires 25 of the first flexible linkage member 21 and has one end portion 29a connected to the movable frame 8 is inserted into the screen 1 in the expansion and contraction direction thereof, deflected downward at the longitudinal frame member 4 opposed to the movable frame 8 through the intermediation of the screen 1, turned back by a deflector 30 provided to the longitudinal frame member 4 at the lower portion of the longitudinal frame member 4, and then directed upward. After that, the leading end of the wire 29 is fixed to the top of the screen guide 10 in the longitudinal frame member 4.

The third flexible linkage member 23 is not always necessary because, similarly to the second flexible linkage member 22, the third flexible linkage member 23 functions to move the movable frame 8 parallel. However, the third flexible linkage member 23 may be provided as a substitute of the second flexible linkage member 22.

The above-mentioned screen device makes it possible to adjust the longitudinal dimension of a screen device provided with the parallel motion mechanism utilizing the wires inserted into the screen 1, by cutting upper portions of the screen 1, the movable frame 8, and the longitudinal frame members 4 and 5 of the screen frame 3. Therefore, it is necessary to prevent cutting of the wire inserted into the screen 1, the movable frame 8, and the longitudinal frame members 4 and 5 of the screen frame 3 when cutting the upper portions of the screen 1, the movable frame 8, and the longitudinal frame members 4 and 5. It is of course necessary to provide measures to prevent obstructions to the cutting. One example of such measures is providing a slit to the longitudinal frame member 4 that lead the wires 25 to the outside of the longitudinal frame member 4 even if the wires 25 constituting the first flexible linkage member 21 is constituted so as to be inserted into the longitudinal frame member 4 and led to the upper end thereof.

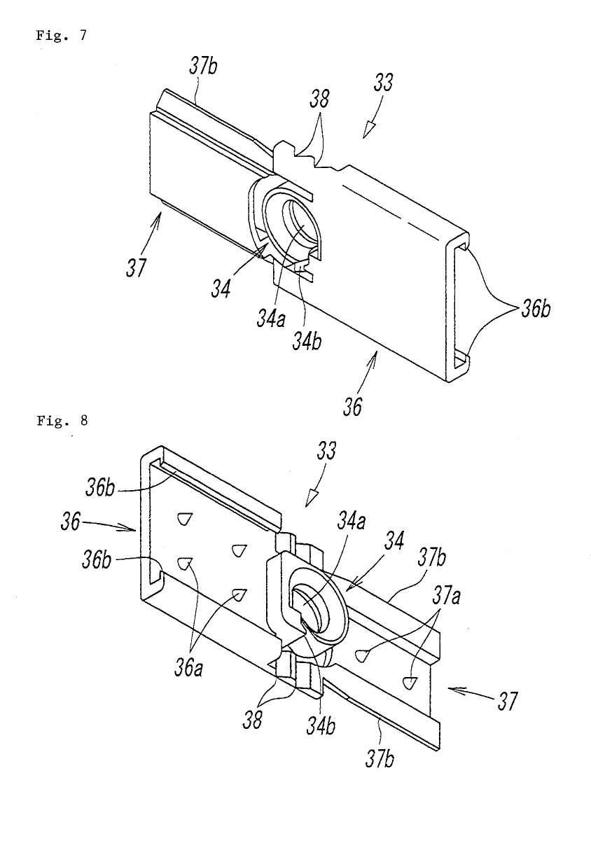

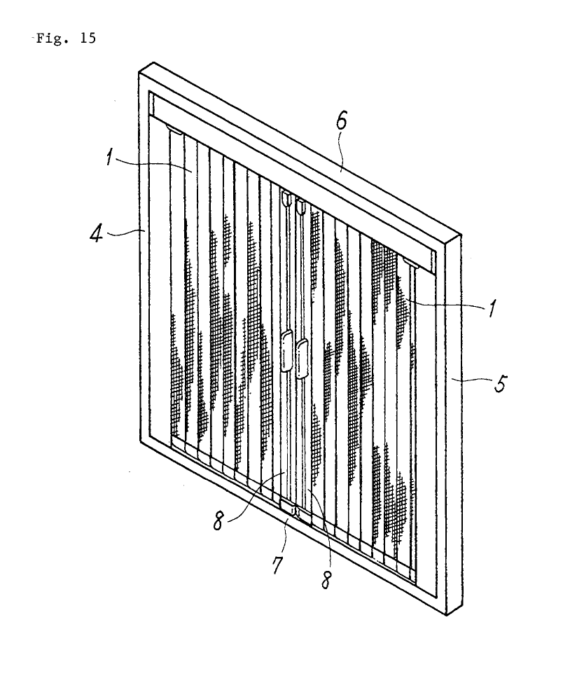

The wires 25 of the first flexible linkage member 21 or the wire 28 of the second flexible linkage member 22 constituting the parallel motion mechanism are tensioned in the upper lateral frame member 6 between the deflector 26 on the side of the one longitudinal frame member 4 and the deflector 27 on the side of the other longitudinal frame member 5 along the portion above the screen 1 without being inserted into the screen 1. As illustrated in FIGS. 1 and 14, a part of or all of the wires in the portion between the deflector 26 and the deflector 27 are used for the purpose of hanging the screen. There are used hanging members 33 as illustrated in FIGS. 7 to 13 for hanging the screen 1. The wire for hanging the screen is inserted into an inner hole 34a of a ring portion 34 of the hanging member 33, and the upper end of the screen 1 is sandwiched in a sandwiching portion 35 of the hanging member 33, so that the upper end of the screen 1 is hanged on the wire for hanging the screen.

Referring to FIGS. 7 to 13, detailed description is further made of the constitution of the hanging member 33. The hanging member 33 is integrally formed of a synthetic resin, and includes the ring portion 34 and the sandwiching portion 35. The sandwiching portion 35 is formed by bendably connecting, through the intermediation of a thin flexible portion 38, a pair of sandwiching plate portions 36 and 37 sandwiching the screen 1. The pair of sandwiching plate portions 36 and 37 are provided with protrusions 36a and 37a, respectively, pinned to the screen 1 sandwiched between opposing surfaces of the sandwiching plate portions 36 and 37. Further, at respective side end portions of the pair of sandwiching plate portions 36 and 37, there are provided engaging portions 36b and 37b, respectively, for maintaining a joining state of the sandwiching plate portions 36 and 37 with sandwiching the screen 1. Further, the sandwiching plate portion 36 is integrally provided with the ring portion 34 having a slit 34b through which the wire for hanging the screen is inserted into the inner hole 34a.

The screen device having the above-mentioned structure realizes a screen device having the parallel motion mechanism using the wires inserted into the screen 1 in which adjustment of the longitudinal dimension is possible by cutting upper portions of the screen 1, the movable frame 8, and the longitudinal frame members 4 and 5 of the screen frame 3. After such adjustment, the screen device is assembled. Subsequently, as illustrated in FIG. 1, a large number of hanging members 33 are attached to the wire for hanging the screen. Specifically, the wire for hanging the screen is inserted into the inner hole 34a through the slit 34b of the ring portion 34 of the hanging member 33 to thereby attach the hanging members 33 to the wire. The upper end of the screen 1 is sandwiched between the sandwiching plate portions 36 and 37 of the hanging members 33 so that the upper end portion of the screen 1 is kept stable. As a result, the upper portion of the tensioned screen 1 can be prevented from bending by an external force such as wind.

FIG. 15 illustrates a second embodiment of a screen device of this invention. The above-mentioned first embodiment shows a screen device in which one side of a single screen 1 is made openable by the movable frame 8 attached to one end thereof. On the other hand, this screen device of the second embodiment provides a screen device in which both sides of the screen device are made openable by attaching the screens 1 and 1 to the left side longitudinal frame member 4 and the right side longitudinal frame member 5, respectively, and attaching the movable frames 8 and 8 to leading ends of the screens 1 and 1. That is where the screen device of the second embodiment is different from the screen device of the first embodiment.

However, the screen device of this second embodiment can be basically obtained by merely arranging the screen 1 and the movable frame 8 which are the same as those of the first embodiment so as to oppose the other screen 1 and the other movable frame 8. Therefore, the differences between the second embodiment and the first embodiment are merely the points mentioned below, and hence description of the screens 1 and the movable frames 8 will be omitted.

The second embodiment is different from the first embodiment in that, as described above, one ends of the screens 1 and 1 are connected to the pair of longitudinal frame member 4 and the longitudinal frame member 5, respectively, of the screen frame 3 installed in an opening of a building, and the movable frames 8 and 8 are connected to the other ends of the screens 1 and 1, respectively, to thereby make the screens 1 and 1 openable and closable by lateral pulling. In the second embodiment, the first and third flexible linkage members 21 and 23 in the parallel motion mechanism for moving parallel the movable frames have the same structures as those of the first embodiment.

However, positions at which the wires 25 of the first flexible linkage members 21 constituting the parallel motion mechanism is deflected at the upper ends of the longitudinal frame members 4 and 5 toward the longitudinal frame members 5 and 4 provided on the other side thereof and turned back by the deflectors 27 are not limited to the positions of the opposed longitudinal frame members 4 and 5. It is sufficient that the deflectors 27 are provided at positions at least beyond a portion at which the movable frames 8 and 8 meet each other. This is also applicable to the case of providing the second flexible linkage members 22.

Further, while this second embodiment shows a case in which there is provided a lateral frame member 7 at a lower portion for connecting the lower ends of the longitudinal frame members 4 and 5, it is also possible to provide, similarly to the first embodiment, the second flexible linkage member 22 constituted by the screen guide 10 and the wire 28 connected thereto, the screen guide 10 being connected to the lower end of the movable frame 8, moving together with the movable frame 8, going into and out of the longitudinal frame members 4 and 5 opposed to each other through the intermediation of the screen 1. In this case, positions of the deflectors 27 are the same as the position in the case of the first flexible linkage member 21.

Please note that the hanging members 33 which are the same as those described in the first embodiment can be used as they are in the second embodiment.

### DESCRIPTION OF REFERENCE NUMERALS

1 screen

3 screen frame

4, 5 longitudinal frame member

6 lateral frame member

8 movable frame

10 screen guide

21˜23 flexible linkage member

25, 28, 29 wire

25a one end portion

26, 27 deflector

33 hanging member

34 ring portion

34a inner hole

34b slit

35 sandwiching portion

36, 37 sandwiching plate portion

36a, 37a protrusion

36b, 37b engagement portion

38 thin flexible portion

1. A screen device comprising:
a screen frame installed in an opening of a building;
a pair of longitudinal frame members in the screen frame;
a movable frame for an opening and closing operation guided by the screen frame;
a screen that is expandable and contractible by being folded in opposite directions alternately, the screen having one end connected to one of the pair of longitudinal frame members and an another end connected to the movable frame, the screen being made openable and closable by lateral pulling;
a parallel motion mechanism for moving parallel the movable frame;
wires inserted into the screen in an expansion and contraction direction of the screen at a plurality of levels; and
a flexible linkage member including the wires, the flexible linkage member retaining a posture of the movable frame in an upright state regardless of a position of the movable frame,
wherein a part of the wires constituting the parallel motion mechanism are tensioned in a lateral frame member without being inserted into the screen along a portion above the screen so as to hang the screen, the lateral frame member being provided in an upper part of the screen frame; and
a hanging member for hanging the screen on the part of the wires used for hanging the screen includes a ring portion having an inner hole into which the part of the wires used for hanging the screen are inserted, and a sandwiching portion for sandwiching an upper end of the screen.

2. The screen device according to claim 1,
wherein respective one end portions of the plurality of wires constituting a part of the parallel motion mechanism are fixed to the movable frame,
the wires are inserted into the screen in the expansion and contraction direction of the screen discretely at a plurality of levels,
the wires are deflected upward in one of the longitudinal frame members opposed to the movable frame through an intermediation of the screen,
the wires are further deflected at an upper end of the one of the longitudinal frame members toward an another one of the longitudinal frame members, then turned back at the another one of the longitudinal frame members by a deflector, and fixed to an upper end of the movable frame, and
a flexible linkage member attached to a lower end of the movable frame is deflected at a lower end of the one of the longitudinal frame members to which the screen is attached, guided to the upper end of the one of the longitudinal frame members, deflected at the upper end, turned back at the another one of the longitudinal frame members, and fixed to the upper end of the movable frame.

3. A screen device comprising:
a screen frame installed in an opening of a building;
a pair of longitudinal frame members in the screen frame;
movable frames for an opening and closing operation guided by the screen frame;
screens that are expandable and contractible by being folded in opposite directions alternately, the screens each having one end connected to the pair of longitudinal frame members and an another end connected to the movable frames, the screens being made openable and closable by lateral pulling;
parallel motion mechanisms for moving parallel the movable frames;
wires inserted into the respective screens in expansion and contraction directions thereof at a plurality of levels; and
flexible linkage mechanisms including the wires, the flexible linkage mechanisms retaining postures of the respective movable frames in upright states regardless of positions of the movable frames,
wherein a part of the wires constituting the parallel motion mechanisms are tensioned in a lateral frame member without being inserted into the screens along portions above the screens so as to hang the screens, the lateral frame member being provided in an upper part of the screen frame; and
a hanging member for hanging the screens on the part of the wires used for hanging the screens includes a ring portion having an inner hole into which the part of the wires used for hanging the screens are inserted, and a sandwiching portion for sandwiching upper ends of the screens.

4. The screen device according to claim 3,
wherein respective one end portions of the plurality of wires constituting a part of the parallel motion mechanisms are fixed to the paired movable frames;
the wires are inserted into the respective screens in the expansion and contraction directions of the screens discretely at a plurality of levels,
the wires are deflected upward in the longitudinal frame members opposed to the movable frames, respectively, through an intermediation of the screens,
the wires are further deflected at upper ends of the respective longitudinal frame members toward the longitudinal frame members provided on other sides therefrom, then turned back by deflectors at positions at least beyond a position where the movable frames meet each other, and fixed to upper ends of the movable frames,
flexible linkage members attached to lower ends of the respective movable frames are deflected at lower ends of the respective longitudinal frame members to which the screens are attached, guided to the upper ends of the longitudinal frame members, then deflected toward the longitudinal frame members provided on the other sides therefrom, turned back at positions at least beyond the position where the movable frames meet each other, and fixed to the upper ends of the movable frames.

5. The screen device according to claim 2,
wherein the flexible linkage member attached to the lower end of the movable frame comprises:
a flexible screen guide that gets into and out of the longitudinal frame member opposed to the movable frame through the intermediation of the screen from a lower end thereof, is led out along a lower end of the screen when the screen is tensioned, and guides the lower end of the screen; and
a wire that is connected to a top of the screen guide inserted into the longitudinal frame member from the lower end thereof and is guided to the upper end of the longitudinal frame member, and
the wire is guided to the upper end of the longitudinal frame member, turned back after being deflected toward the longitudinal frame member provided on an another side, and fixed to the upper end of the movable frame.

6. The screen device according to claim 1,
wherein the hanging member is integrally formed of a synthetic resin,
a sandwiching portion of the hanging member is formed by bringing a pair of sandwiching plate portions sandwiching the screen into bendably contact with each other through an intermediation of a thin flexible portion,
the pair of sandwiching plate portions is provided with protrusions that are pinned to the screen sandwiched between opposing surfaces of the pair of sandwiching plate portions and an engaging portion for holding the sandwiching plate portions in a joining state with the screen being sandwiched between the pair of the sandwiching plate portions, and
at least one of the sandwiching plate portions is integrally provided with the ring portion having a slit through which the part of the wires for hanging the screen is inserted into the inner hole of the ring portion.

7. The screen device according to claim 4,
wherein the flexible linkage member attached to the lower end of the movable frame comprises:
a flexible screen guide that gets into and out of the longitudinal frame member opposed to the movable frame through the intermediation of the screen from a lower end thereof, is led out along a lower end of the screen when the screen is tensioned, and guides the lower end of the screen; and
a wire that is connected to a top of the screen guide inserted into the longitudinal frame member from the lower end thereof and is guided to the upper end of the longitudinal frame member, and
the wire is guided to the upper end of the longitudinal frame member, turned back after being deflected toward the longitudinal frame member provided on an another side, and fixed to the upper end of the movable frame.

8. The screen device according to claim 3,
wherein the hanging member is integrally formed of a synthetic resin,
a sandwiching portion of the hanging member is formed by bringing a pair of sandwiching plate portions sandwiching the screen into bendably contact with each other through an intermediation of a thin flexible portion,
the pair of sandwiching plate portions is provided with protrusions that are pinned to the screen sandwiched between opposing surfaces of the pair of sandwiching plate portions and an engaging portion for holding the sandwiching plate portions in a joining state with the screen being sandwiched between the pair of the sandwiching plate portions, and
at least one of the sandwiching plate portions is integrally provided with the ring portion having a slit through which the part of the wires for hanging the screen is inserted into the inner hole of the ring portion.
